(19) United States
(12) Patent Application Publication
(10) Pub. No.: US 2007/0204187 A1
(43) Pub. Date: Aug. 30, 2007

(54) METHOD, SYSTEM AND STORAGE MEDIUM FOR A MULTI USE WATER RESISTANT OR WATERPROOF RECORDING AND COMMUNICATIONS DEVICE

(75) Inventors: Joseph P. DeMarco, Newburgh, NY (US); Daniel J. Peters, Poughquag, NY (US)

Correspondence Address: FREDERICK W. GIBB, III;Gibb & Rahman, LLC, 2568-A RIVA ROAD, SUITE 304, ANNAPOLIS, MD, 21401, US

(73) Assignee: INTERNATIONAL BUSINESS MACHINES CORPORATION, Armonk, NY (US)

(21) Appl. No.: 11/307,922

(22) Filed: Feb. 28, 2006

(51) Int. Cl. G06F 11/00

(52) U.S. Cl. 714/15

(57) ABSTRACT

A method, system and storage medium for a multi-use water resistant or waterproof recording and communications device. A network system of embodiments herein comprises an information engine to integrate a plurality of system components and a server to execute the information engine. The system further comprises a storage system to store electronic information to be retrieved and manipulated by the server, and a network to connect the server to a plurality of client systems. More specifically, the system components comprise a workflow management component, a permissions component, a security component, a voice identification component, a voice-to-text conversion component, a template component, language translation component, a transcription service component, an analytics component, and an upgrade component. The workflow management component processes incoming transmissions and places date, time, and/or geographic location stamps on system transactions.

### BACKGROUND

1. Field of the Invention

Embodiments herein present a method, system and storage medium for a multi-use water resistant or waterproof recording and communications device.

2. Description of the Related Art

The current state of voice recording is primarily associated with dry or benign weather environments. The recorders are of electromagnetic variations whose water resistance is a consequence of meeting minimum safety standards and do not possess a security feature to protect the content of that recording. Recording systems have been integrated into voice recognition systems, voice-to-text conversion capability i.e., reordering supplies and translation services, but only to a very limited degree.

The related art discloses disparate capabilities such as analog recording, analog to digital conversion, digital to analog conversion, voice mail, memo services, voice message formats, voice recognition, encryption schemes, portable electronic devices, submersible aural and auditory systems, and transmission from a recording device to a remote device via a network.

Embodiments herein overcome the limitations of the current art concerning inclement weather, wet environments, and digital documentation. Embodiments of the invention further extend the use of digital recordings with translation, transcription, and voice-to-text conversion within a system architecture. Embodiments of the invention further provide end-to-end integration from the initiator (device user) to the authorized recipients.

### SUMMARY

Embodiments herein present a method, system and storage medium for a multi-use water resistant or waterproof recording and communications device. A network system of embodiments herein comprises an information engine to integrate a plurality of system components and a server to execute the information engine, wherein the system components and the server are operatively connected to the information engine. The system further comprises a storage system to store electronic information to be retrieved and manipulated by the server, and a network to connect the server to a plurality of client systems, wherein the storage system and the network are operatively connected to the server.

More specifically, the system components comprise a workflow management component, a permissions component, a security component, a voice identification component, a voice-to-text conversion component, a template component, language translation component, a transcription service component, an analytics component, and an upgrade component. The workflow management component processes incoming transmissions and places date, time, and/or geographic location stamps on system transactions.

Furthermore, the permissions component permits user access into the information engine; and the security component protects received information. Additionally, the voice identification component determines spoken language and identifies a speaker; and the voice-to-text conversion component converts speech into text. Moreover, the template component stores pre-formatted recording templates; and the language translation component translates the text via the voice-to-text conversion component to a specified language. Further, the transcription service component provides transcriptionists and interpreters to ensure that the text is grammatically correct; and the analytics component builds data models that analyze verbal information. Finally, the upgrade component maintains records of hardware or software upgrades or options to recording and communication devices.

With regards to the client systems, they comprise a system administrator, a system supervisor, a device user, a transcriptionist, an analyst, an authorized recipient, and an upgrade coordinator. Specifically, the system administrator manages the server, the storage system, and the network; and the system supervisor controls the workflow management component, the permissions component, and the security component. Furthermore, the device user transmits data to the information engine; and the transcriptionist provides quality control over the voice-to-text conversion component or the language translation component. Moreover, the analyst manages the analytics component; and the authorized recipient receives information from the device user. Finally, the upgrade coordinator manages upgrades and/or options to hardware or software components of the recording and communication device.

Embodiments of the invention further comprise a waterproof recording and communications device, comprising a bus operatively connected to a control element, a control interface, an input/output interface, and a communications interface. More specifically, the bus allows independent access to a memory element operatively connected to the bus, wherein the memory element comprises program memory for data and applications. The control element directs the applications; and the control interface receives instructions from the control element and sends signals to a processing unit, wherein the signals comprise instructions to the processing unit to perform the applications.

Further, the input/output interface interfaces the bus, a receiver, and a transmitter, wherein the receiver converts verbal information from a microphone to digital information. The microphone comprises an internal microphone and/or an external microphone, wherein the internal microphone receives verbal information and sends the verbal information to the storage unit via the input/output interface and the receiver. The external microphone also sends the verbal information to the receiver. In addition, the receiver sends the digital information to the bus, the input/output interface, and the storage unit, wherein the storage unit places date, time, and/or geographic location stamps on the digital information. Moreover, the transmitter converts the digital information from the storage unit or the input/output interface to verbal information, wherein the transmitter sends the verbal information to an internal speaker or an external aural device. Additionally, the communications interface interfaces the bus and a communications device, wherein the communications device operatively connects the device to a network. The microphone, the storage unit, the communications interface, and the communications device are each operatively connected to the bus.

The waterproof recording and communications device further comprising an encryption element to provide security of the digital information and a global positioning system element to identify the geographic position of the device when the verbal information is received by the microphone. The encryption element and the global positioning system element are operatively connected to the bus. The device further comprises a case to enclose the device, wherein the case is water resistant or waterproof. The case permits hermetically sealed electronic interfaces between the visual display interface and the control interface; the transmitter and the aural device; the receiver and the external microphone; the internal power supply and the recharger; the internal power supply and the external power supply; the communications interface and the communications device; or, the communications device and the network.

A visual display interface is also provided to display the status of the device, as well as an internal speaker to receive and transmit verbal comments from the storage unit. The visual display interface and the internal speaker are operatively connected to the bus. The device also comprises an aural device operatively connected to the bus to receive and transmit verbal comments from the transmitter.

Embodiments of the invention further comprise a method of utilizing the waterproof recording and communications device, comprising configuring a recording and communications device with settings and options through a control interface. Next, information is recorded within the recording and communications device, wherein the information is stored within a storage unit. The recording of the information may be conducted in a wet environment. Moreover, the information can be stamped with date, time, and/or geographic location data. The method then transmits the information to an information engine via a network, a server and the storage unit.

When the device user or the recording and communications device cannot be verified, a denial message is sent to a device user via a permissions component and remedial log in procedures are initiated. Subsequently, when the device user or the recording and communications device can be verified, the method further comprises queuing device user information and communications for processing by a workflow management component.

Following this, when decryption of the communications is required, a security component is invoked. When the language and the device user are verified, a voice identification component is invoked. Next, the information is converted to text via a voice-to-text conversion component. When the templates are used, the text is transferred to templates retrieved from a template component. Further, when the language translation of the text is required, language translations of the text are conducted via a language translation component. Moreover, when the transcription of the text is required, transcription of the text is performed via a transcription component.

The method then provides the templates to device users and authorized recipients. When analysis is required, analytics are performed via an analytics component to model structured and unstructured data. The results of the analytics are subsequently provided to authorized recipients. Following this a workflow record is completed and closed.

Accordingly, embodiments of the invention present the audio recording of thoughts and messages, and the transmission of those ideas and messages for transcription, analysis and/or action. Embodiments herein can be used in a wet environment, either resisting water i.e., rain, shower, environmental assessments of wetlands, etc. or submersed in water i.e., scuba diving, military operations, intelligence gathering, etc. In the event of potential information being confidential, there is a security feature to protect that material. Embodiments herein have the ability to place date, time and/or location electronic stamps on the recording for legal reasons, ready identification, and/or document processing.

Embodiments of the invention may be used in a dry or wet environment. Therefore, at a minimum, the device can be water resistant for inclement weather or damp conditions. In extreme situations, waterproofing is useful to the intended immersion point. Embodiments herein provide a recording device that can be used within dry and wet environments which is the entry point into an automated systems architecture for a combination of voice recognition, voice-to-text conversion capability, language translation, analysis and transcription service. A systems architecture of these capabilities is disclosed herein to advantageously improve personal and group productivity and save costs.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a diagram illustrating a system architecture as an exemplary embodiment;

FIG. 2 is a block diagram illustrating a water resistant or waterproof recording and communications device as an exemplary embodiment;

FIGS. 3A-B are flow diagrams illustrating a method of using the water resistant or waterproof recording and communications device as an exemplary embodiment;

FIG. 4 is a flow diagram illustrating a hardware and/or software upgrade and/or option ordering process; and

FIG. 5 is a diagram illustrating a computer system as an exemplary embodiment.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

Accordingly, embodiments of the invention present the audio recording of thoughts and messages, and the transmission of those ideas and messages for transcription, analysis and/or action. Embodiments herein can be used in a wet environment, either resisting water i.e., rain, shower, environmental assessments of wetlands, etc. or submersed in water i.e., scuba diving, military operations, intelligence gathering, etc. In the event of potential information being confidential, there is a security feature to protect that material. Embodiments herein have the ability to place date, time and/or location electronic stamps on the recording for legal reasons or document processing.

Embodiments of the invention may be used in a dry or wet environment. Therefore, at a minimum, the device can be water resistant for inclement weather or damp conditions. In extreme situations, waterproofing is useful to the intended immersion point. Embodiments herein provide a recording device that can be used within dry and wet environments which is the entry point into an automated systems architecture for a combination of voice recognition, voice-to-text conversion capability, language translation, analysis and transcription service. A systems architecture of these capabilities is disclosed herein to improve personal and group productivity and save costs.

Embodiments herein combine hardware in context of a system architecture to record and communicate verbal information from a user to other authorized recipients. There are situations that require voice recording in both benign (dry) and electronically hostile (wet) environments. Embodiments of the invention are either waterproof (impervious to water) or water resistant (does not entirely prevent the penetration of water) depending on the implementation or intended use.

Several scenarios are used to illustrate the broad possibilities of embodiments of the invention. The scenarios are not exhaustive, rather they demonstrate the flexibility of embodiments herein and the actual implementation will determine the configuration of the system architecture and hardware. Additionally, there is a natural product life cycle where systems and devices go through phases. Initially, physical systems and devices are expensive and marketed to small customer sets. As the technology evolves and is adapted, the scale of manufacturing makes the systems and devices into commodities. Once systems and devices are affordable to the populace, customization in design and features becomes more important than the actual function.

One intended use of embodiments herein is to record innovative thoughts of individuals while in the shower, hot tub, bathtub, by the swimming pool, etc. When people are in a relaxing and comfortable environment, their thoughts can be focused on creative activities or problem solving. However, in these situation, writing their ideas or thoughts may not be convenient or practical. Therefore, an oral transcript of their instantaneous thoughts that can be replayed at a later time for use or analysis. For inventors, they would be able to capture their ideas, share them with co-inventors, and log (date-time stamp) their ideas as part of the legal documentation in the event of an Office action or court case. This could be marketed as an innovation recorder.

Another way embodiments of the invention could be used is as an electronic diary. For individual users, an electronic diary may be a more convenient means to record daily musings than the traditional pen and paper diary. Embodiments herein would be very useful for the physically disabled with paralysis or neurological disorders, persons who experience discomfort when working with computers, individuals with hearing impairments (i.e., tinnitus, deafness, etc.) or those who suffer from dyslexia.

Public safety personnel may be required at a scene of an automobile accident to make a report from their perspective of their responses. Law enforcement personnel will need to record statements of the people involved in the accident, ensure Miranda rights have been read in the case of an arrest, obtain first hand impressions of witnesses, etc. The police officer responding to the accident could have a pre-format accident report within the device that provides verbal responses to aural cues provided by the recorder. Firefighting personnel may need to describe their response to the accident such as putting out fires or extracting victims from the vehicles. Emergency medical personnel may need to provide a running transcript of medical history considered, symptoms presented, treatment provided, oral refusal of treatment by accident victims, etc. These three public safety perspectives are necessary to gather a complete picture of the accident, which may include date, time and location electronic stamps. In the event of legal actions, these recordings form the base electronic documentation that could be used in a court of law.

In some countries or international organizations, there are multiple official languages. Embodiments herein allow for voice transmission to the application in one language and translation to native language of the recipients. In the above scenario where English and French are the two official languages of Canada, the mother tongue of the officer may be English, and the police report could be printed in both French and English by answering the formatted questions. The device will record the officer's answers to the pre-formatted questions and transmit that verbal information to the application. In this case, the application will receive the verbal information in English, convert the oral information to English text, and translate the text to French.

Military, diplomatic and intelligence professionals could use the invention for providing periodic situation reports or field interviews. In these situations, having a date, time and location stamp will reduce reporting requirements and enhance accuracy. Utility personnel could use embodiments of the invention for conducting assessments and/or report repairs for power grids, sewer systems, pipelines, etc. Environmental teams could record their impressions during assessments of swamps, reefs, etc. The notion is that there are many professions that require verbal and instantaneous information when in possibly wet environments or in inclement weather. These assessments may include natural or man-made disasters, or be a routine part of their professional life. Therefore the implementations of embodiments herein have numerous permutations depending on the intended use.

In a man-made or natural disaster relief situation, first responders, governmental agencies and non-governmental organizations (NGOs) will be conducting assessments and providing humanitarian aid. The recording and transmission of pre-formatted and unformatted verbal information, and electronic stamps of date, time and/or location data from disparate locations is necessary to form a complete picture of the disaster and the evolving needs that require immediate assistance. In many large scale disasters, there may be an international response. The governmental agencies could provide recording and communications devices to first responders, governmental officials and NGOs. These individuals would be empowered to provide verbal information in their native tongue. The verbal assessments could be provided to humanitarian assistance coordinating agencies via embodiments of the invention. These coordinating agencies could be at local, national and/or international levels. Embodiments herein would deliver the verbal information as printed or audible form, translated to the recipient's mother tongue. The value propositions of embodiments of the invention are to increase the speed of the response to emergent situations, and to create a faster and more complete picture of needs since disasters normally involve a great deal of chaos.

In multinational peacekeeping operations there is need for the troops in the field to provide reports to their headquarters. These reports are essential for commanders to take appropriate and timely actions depending on the situation. In many cases, the language spoken by the troops in the field is different than the language spoken by the headquarters. Embodiments herein provide near real-time translation service without having to go through intermediaries whose translation abilities can vary in quality. Additionally, date, time and/or location information is critical to intelligence, operations, and logistics for peacekeeping missions.

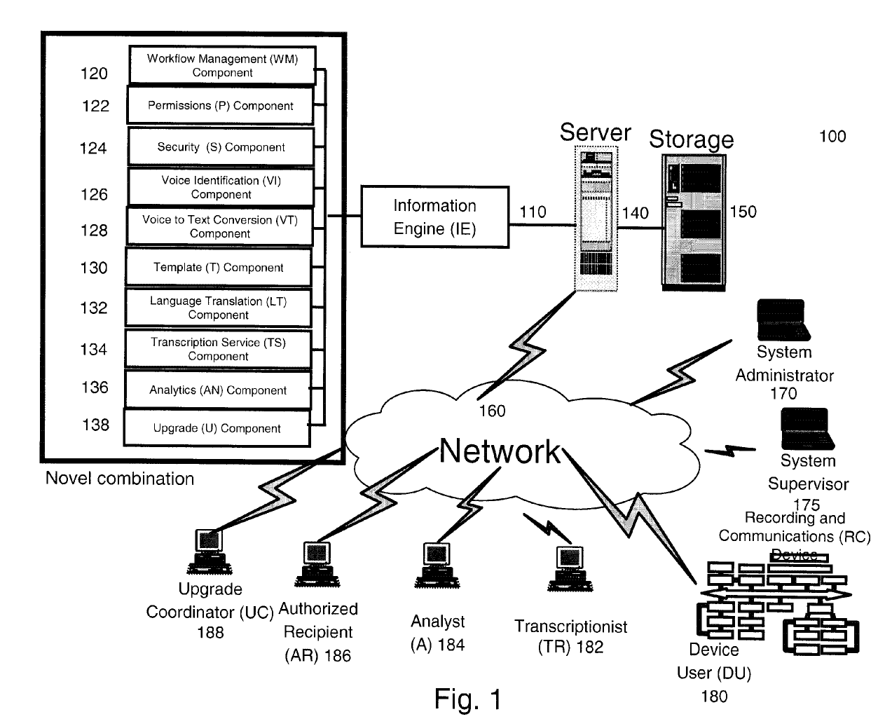

Turning now to FIG. 1, a network system 100 for implementing a method will now be described. System 100 includes a host system or server 140 executing the Information Engine 110. The Information Engine 110 integrates the different components of embodiments of the invention. For example, the components could include: Permissions component 122, Security component 124, Voice Identification component 126, Voice-to-Text Conversion component 128, Template Component 130, Language Translation component 132, Transcription Service component 134, Analytics component 136 and Upgrade component 138. Those skilled in the art would appreciate that the implementation of embodiments of the invention will vary in the components used depending on the objectives and intended use.

The Workflow Management component 120 is an automated system that monitors events within the Information engine 110 and components 122 through 138, queues activities to specific components, users or work groups, delivers reminders to individual users or work groups, and alerts supervisors when actions have not been completed within the time prescribed. The Workflow Management component facilitates the expeditious processing of incoming transmissions. The Workflow Management component date-time stamps all transactions for processing purposes, which is different from the date-time stamps from the user device 180.

The Permissions component 122 is an automated system used for user log in and password entry into the Information engine 110 for all users. This protects information and provides the appropriate entitled data to specific users. The Permissions component will identify all users and devices by their access authorization.

The Security component 124 protects the information being received and in some cases transmitted to other users 180 or analysts 184. The Security component may use encryption and decryption technology suitable for the sensitivity of the material or security classification. The Security component is upgraded with the requisite technology as the situation dictates (i.e., security was compromised, etc.) or the security needs have increased.

The Voice Identification component 126 will determine the language spoken and identify who is the speaker. Confirmation of the speaker can be used as an additional security check in conjunction with the Permissions component 122. Incoming verbal information may be routed to the applicable parts of the Voice-to-Text Conversion 128 and Language Translation 132 components. The Voice Identification component may learn to recognize the various voices and provide a degree of customization due to varying accents and inflection. This customization may be interactive with the Voice-to-Text Conversion component 128.

The Voice-to-Text Conversion component 128 enables digitally recorded speech to be converted to text via natural language processing. The speech may be discrete (a short pause between words) or continuous (more than 100 words per minute). The component enables one or more languages to be converted into text which supports the Template 130 and Language Translation 132 components. The Voice-to-Text Conversion component can provide grammatical context and frequency of use statistical techniques to determine the correct words to improve the accuracy of the conversion. This component can assist the hearing impaired to understand the verbal information provided by the device user 180.

The Template component 130 contains pre formatted templates that can be created and maintained. These could be an innovation ideas diary, electronic medical records, police reports, standardized military or intelligence situation reports, etc. The recorded speech from the recording and communications device would be used to populate these pre formatted templates. The electronic recordings appropriately filed will evolve administrative practices, electronically manage data, and replace paper copies. Electronic stamps of date, time, and location may be automatically populated from the user device 180.

The Language Translation component 132 enables the simultaneous translation of text from the Voice-to-Text Conversion component 128 to one or more specified languages to be used within the Template 130, Transcription Service 134, and Analytics 136 components.

The Transcription Service component 134 provides professional transcriptionists and interpreters to ensure the text makes grammatical sense. The transcriptionist may also print, mail, FAX or electronically transmit the final version to the device user 180, analysts 184 or other authorized recipients 186. In some cases, the transcriptionist will convert the text to Braille for blind users.

The Analytics component 136 is used to build data models that analyze the verbal information provided and other key measurements that are translated into future activities. The Analytics component is updated on a scheduled basis and as models are refined and refreshed. The Analytics component could provide trend analysis, aggregated information, predictive insight, etc. Additionally, analyses relative to date, time and location can also be performed based on the scope of implementation of the user device 180.

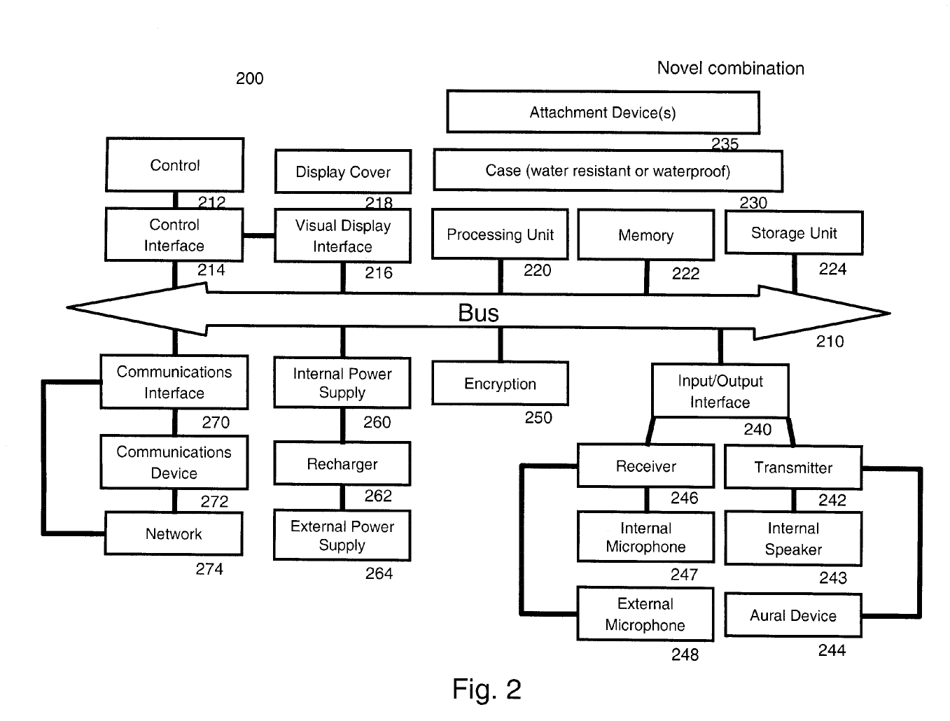

The Upgrade component 138 is managed by the Upgrade Coordinator 188 and maintains records of hardware and/or software upgrades and/or options to recording and communication devices. The Upgrade component 138 can validate product configurations for compatibility and recommend up-sell and cross-sell opportunities, and has an order taking capability. As identified in FIG. 2, hardware upgrades include the memory 222, storage 224 encryption 250, and Global Positioning System (GPS) 255 elements. Software upgrades include the memory 222 and encryption 250 elements. Options include display cover 218, attachment device 235, aural device 244, external microphone 248, recharger 262, communications device 272, delivery modalities, warranties, etc.

An up-sell opportunity is where a user is sold a more richly-configured solution within the same good or service family above the customer's selected price range that satisfies the availability requirement. Incentives may be used to entice customers to agree to an up-sell. A cross-sell opportunity provides complimentary goods and services based on the goods or services the user has selected. Examples include shipping, warranty, accessories, or peripherals. Volume discounts may apply to cross-sell items. Cross-selling is often called “clothing the deal”.

The server 140 may be connected to a Storage system 150 and through a Network 160 to client systems 170-188 or other networks. The server 140 may be implemented using one or more servers operating in response to a computer program stored in a storage medium accessible by the server. The server 140 may operate as a network server (e.g., a web server) to communicate with the client systems 170-188. The server 140 handles sending and receiving information to and from client systems 170-188 and can perform associated tasks. The server 140 executes various applications typically found in a business enterprise.

The server 140 may include an IBM® eServer™ (iSeries™, pSeries™, xSeries™ or zSeries™), available from IBM Corporation, Armonk, N.Y., USA, or any other suitable commercially-available computer systems depending on the scope of the implementation. The server may execute web server software designed to accommodate various forms of communications, including voice, video, and text typically utilized by large business enterprises. Any web server software or similar program that handles general communications protocols and transport layer activities could be used as appropriate for the network protocol in use. For purposes of illustration, the server is running IBM's Lotus Domino™ and Lotus Notes™, available from IBM Corporation, Armonk, N.Y., USA, as its groupware applications software; however, any compatible e-mail-integrated, web-enabled collaborative software could be used.

The storage system 150 may be implemented using a variety of devices for storing electronic information. It is understood that this device may be implemented using memory contained in the server 140 or it may be a separate physical device. The storage system 150 is logically addressable as a consolidated data source across a distributed environment that includes a network 160. Information stored in the storage system 150 may be retrieved and manipulated via the server 140. The storage system 150 includes a data repository containing documents, data, web pages, images, multimedia, etc. Further, the storage system 150 stores configuration files (also referred to herein as page tokens). In an exemplary embodiment, the server 140 operates as a database server and coordinates access to application data including data stored within the storage system 150.

The storage system 150 comprises any form of mass storage device configured to read and write database-type data maintained in a file store (e.g., a magnetic disk data storage device). The storage system can range from a single Hard Disk Drive on a personal computer to a large enterprise storage systems, i.e., IBM's Shark™. It will be appreciated that the storage system may be one that consists of multiple disk subsystems which may be geographically dispersed and coupled via network architecture.

There is no positive requirement that the storage system be maintained in one facility; to the contrary, the volume of information stored therein may dictate geographical dispersion and the like. The storage system is logically addressable as a consolidated data source across a distributed environment such as a network system. The implementation of local and wide-area database management systems to achieve the functionality of the storage system will be readily understood by those skilled in the art. Information stored in the storage system is retrieved and manipulated by a database manager and data mining software. For purposes of illustration, the database manager may be IBM's DB/2® software. The storage system provides a repository for a library of documents and data that are created and utilized by the process.

The network 160 may be any type of known network including, but not limited to, a Local Area Network (LAN), a Wide Area Network (WAN), a global network (e.g., Internet), a Virtual Private Network (VPN), an intranet, or other network configuration known in the art. These networks may be implemented using a wireless network or physically connected to each other in a state of the art configuration, to include a direct cable. One example of a wireless connection is Bluetooth technology. One or more of the client systems 170-188 may be coupled to the server 140 through multiple networks (e.g., intranet and Internet) so that not all of the clients systems 170-188 are coupled to the server 140 through the same network. One or more of the client systems 170-188 and the server 140 may be connected to the network 160 in a wireless fashion. For example, one or more of the client systems 170-188 may execute a user interface application (e.g., a web browser) to contact the server 140 through the network 160, while another client system is directly connected to the server 140. In certain configurations, the device 180 may be directly connected to the server 140, bypassing the network 160. Further, the network may include wireless connections, radio based communications, telephony based communications, and other network-based communications. Secure Socket Layer (SSL encryption) software may be used to control access to host system, limiting permissions to network users, such as remote client systems or vendor systems, who have proper authorization.

The client systems 170-188 comprise general purpose computer devices that allow systems to connect to the network and host system. The client systems may access host via seller's web browsers located therein. Individual client systems are described below, and may include suitable computer systems. Individuals and teams involved in the selling, marketing and merchandising goods or services perform specific roles throughout the described process. They are also in communication with each other via client systems as will be described further herein.

The system Administrator 170 refers to a client system operated to manage the performance, operation, and maintenance of the host system, storage system and networks identified in the foregoing discussion. The system administrator manages the server 140, storage system 150, and network 160.

The system supervisor 175 controls the workflow management 120, permissions 122 and security 124 components. In some deployments, the system administrator 170 may be assigned the system supervisor roles and responsibilities.

The device User 180 is an individual that records speech or verbal information on the recording and communications device and transmits data to the information engine 110 either directly or via the network 160. The user may record ad hoc observations or ideas on the device or respond to specific template questions.

The transcriptionist 182 is a highly trained individual who provides quality control over the output of the conversion or translation process to ensure its completeness and correctness. The transcriptionist may also print, mail, FAX or electronically transmit the final version to the device user 180, analysts 184 or other authorized recipients 186. The transcription may use the voice identification 126, voice-to-text conversion 128, template 130, language translation 132 and transcription service 134 components per the permissions 122 component. If there is more than one transcriptionist, the system supervisor may establish one or more work groups depending on the deployment.

The analysts 184 are skilled individuals who oversee and manage the processes supported by the network 160. The use of the recorded materials range from addressing specific issues to formulating broad solutions. The roles and responsibilities of the analysts are situationally dependent. The analysts will use the template 130 and the analytics 136 components per the permissions 122 component. If there is more than one analyst, the system supervisor may establish one or more work groups depending on the deployment.

The authorized recipient 186 is the intended receiver of information originating from the device user 180 electronically processed via the network 160 and the information engine 110. An authorized recipient is not the transcriptionist 182 or the analyst 184. In some cases, the authorized recipient 186 may be the device user 180. The authorized recipient 186, per the permissions component 122, is entitled to hear or read the communication provided by the device user 180. If there is more than one authorized recipient 186, the system supervisor may establish one or more work groups depending on the deployment.

The upgrade coordinator 188 manages hardware and/or software upgrades and/or options to the recording and communications device. The management of these upgrades may be via automated systems, web interfaces, or telephone sales with the goal of generating more revenue. The hardware upgrades may be via shipping installable products or software keys that activate the additional capability that has been pre-installed. Hardware upgrades include the memory 222, the storage 224, the encryption 250, or the Global Positioning System (GPS) 255 elements, or ancillary features that can be ordered as options. Software upgrades include the memory 222 and the encryption 250 elements. The upgrade coordinator manages the upgrade 138 component per the permissions 122 component.

Turning now to FIG. 2, a block diagram for implementing embodiments of the invention will now be described. The device 200 includes various electrical, electronic and mechanical parts as described following. Those skilled in the art would appreciate that the implementation of embodiments herein will vary in arrangement and elements used depending on the environment or intended use.

The bus 210 is the electrical interface between the various internal elements and external peripherals contained within embodiments of the invention to allow for independent access to the memory 222. The type of bus used will be determined by cost, available technology, internal elements, external peripherals, and the performance requirements of embodiments the invention.

The control 212 is a electrical and/or mechanical element that turns the device 200 “ON” or “OFF” and/or determines the activity of the device 200 (record, transmit, etc.). The control 212 may provide overwrite, insert, delete and security functions. The control 212 may consist of single or multiple buttons or switches. For hands-free control, the control 212 may be voice activated or have a foot switch. The control 212 has the ability to key the processing unit 220 to replay the last voice recorded segment from the storage unit 224. This advantageously provides embodiments herein with a capability allowing the user continuity of thought when there has been a time lapse between recorded thoughts.

The control interface 214 is an electrical element that receives direction from the control 212 and/or the visual display interface 216 as to the specific activity the device 200 is to perform. The control interface 214 provides the specific activity information to the processing unit as an electrical signal to run a specific application. Additional examples of commands from the control 212 or the visual display interface 216 are record (store speech), encrypt speech, passcode initialization or change, play back (hear speech), forward, fast forward, reverse, fast reverse, find, transmit digital speech (unsecured or encrypted), etc. The control interface 214 may monitor the device 200 for lack of activity and provide an automatic save and power off capability after a predetermined time of inactivity.

The visual display interface 216 is an electrical or mechanical visual display of the status of the device 200 (i.e., power “ON”, duration of internal power supply, recording, transmitting, etc.). The visual display interface 216 may include mechanically activated messages, color codes, LED lights, LED panels, touch-screen displays, etc. In some cases, the visual display interface 216 may be a touch-screen display that could be used for activity functions of the control 212 functions. In some implementations, the visual display interface 216 may create basic text messages that may be attached to the digital speech (i.e., priority, routing, etc.). Additional examples of capabilities are displaying device mode (i.e., record, play back, etc.), input text or commands, rejected passcode, power source and/or battery status, communications performance, etc.

The display cover 218 is an optional device that provides physical protection to the visual display interface 216, and in clandestine military or intelligence operations, prevents the display from being seen in a tactical setting.

The processing unit 220 runs applications to control the various elements based upon electronic signals from the control interface 214.

The memory 222 includes internal flash memory to protect key operations when the internal power supply no longer functions and program memory for data and applications. The memory 222 includes an electronic calendar and clock used for providing date and time information. Additionally, it may be required to perform passcode verification. In some cases where the storage capability is small, the storage unit 224 may be fully integrated into the memory 222. The selection criterion for memory is the performance requirements of the invention. Insufficient memory can lead to poor performance. The implementation of embodiments of the invention may include the ability to physically upgrade memory or virtually upgrade memory on demand. In some configurations, an expansion slot may provide additional memory capability at a later time. In some implementations, the additional memory may be resident within the device 200 due to manufacturing cost considerations, to be activated at a later time via a code.

The storage unit 224 provides electrical or digital storage of verbal messages. Each electrical or digital message is date, time and/or location electronically stamped for record purposes. The type of storage medium and electronic formats depends on the specific application and technology available. In some configurations, an expansion slot may provide additional storage capability at a later time. In some implementations, the additional storage may be resident within the device 200 due to manufacturing cost considerations, to be activated at a later time via a code. In some implementations, the storage unit 224 may offer the ability to partition the storage into work folders to assist in management of the recording. For example, the folders could be designated for projects or individuals depending on the intended use.

The case 230 can be either water resistant or waterproof. In either situation, the case 230 can be hermetically sealed to prevent moisture from entering the device 200 and causing the circuits not to function. In those situations where the case 230 will be submersed in water, the case 230 can be able to withstand the pressures exerted by the depth of the water i.e., pounds per square inch. The case 230 can permit hermetically sealed electronic interfaces between the control interface 214 and the control 212, the visual display interface 216 and the control interface 214, the transmitter 242 and the aural device 244, the receiver 246 and the external microphone 248, the internal power supply 260 and the recharger 262 (external or internal) and the external power supply 264, and the communications interface 270 and the communications device (external) 272 or the communications device (internal) 272 and the network 274. The recharger 262 and/or communications device may be internal or external to the case 230 depending on the implementation. The case 230 can be ergonomically designed based on its intended use.

The case 230 can be constructed from plastics, metals, composite materials, and the like so as to be impervious to water and resist pressure when the device is submerged at depth. Those skilled in the art would recognize which materials are suitable for each implementation, to include hermetically sealed interface points with external components. In some cases, the material could be certain plastics that provide waterproofing and resist pressure, with the additional benefit of providing buoyancy. Manufacturing of the device using plastics is advantageous to the device's utility, making the device light weight and buoyant, so the device can float to the surface if submerged and when used in or around liquids.

The attachment device 235 will be affixed to the case 230. There may be one or more attachment devices 235 depending on the intended use. The attachment device 235 provides a means to carry, hold, clip on, affix, hang, etc. the device 200. This also includes a carrying case of appropriate design.

The input/output interface 240 is the electrical and digital interface between the bus 210, the transmitter 242, and the receiver 246.

The transmitter 242 is a digital-to-analog converter from the storage unit 224 (via the bus 210) and the input/output interface 240 to the internal speaker 243 or the external aural device 244. The transmitter 242 may have the ability to amplify the signal. The volume may be adjusted by the control 212 or the visual display interface 216.

The internal speaker 243 is an auditory device so the device user can hear verbal comments from the storage 224 via the bus 210, the input/output interface 240 and the transmitter 242. The internal speaker 243 is optional, and for submersible adaptations will not be used.

The aural device 244 provides assistance or enhances hearing such as ear pieces (in-the ear or on-the-ear) or corded or cordless devices (on-the-ear, behind-the-neck or over-the-head). The aural device 244 receives analog sounds from the transmitter 242. The aural device 244 may be monaural or binaural (stereo or mono). In some instances, the aural device 244 may be integrated with the external microphone 248 to create an integrated headset for hands free operations. The connections between the transmitter 242 and the aural device 244 can either be wireless or through a hermetically sealed physical port in the device 200. The aural device 244 includes a cable adapter plug that is inserted into the hermetically sealed port. The cable may have a quick disconnect capability and/or the capability of having more than one aural device 244 connected to the transmitter 242. The aural device 244 may have cushioning for comfort or have a watertight fit if submerged.

The receiver 246 is an analog-to-digital converter from the internal and/or external microphone to the input/output interface 240, the bus 210 and the storage unit 224. The receiver 246 can also filter out additional background noises for improved sound clarity.

The internal microphone 247 is a built-in microphone for the device user to record verbal comments to storage via the input/output interface 240 and the receiver 246. The internal microphone 247 may have a noise canceling capability to reduce background sounds for clearer recordings or dictation which will enhance the voice recognition software capabilities within the voice identification 126 and the voice-to-text conversion 128 components. For recording conferences, the internal microphone 247 should be omni directional and have sensitivity adjustments via the control 212 or the visual display interface 216. The internal microphone 247 is optional for submersible adaptations.

The external microphone 248 provides a means of sending verbal (analog) messages to the receiver 246. The external microphone 248 can have noise-canceling capabilities, may be in front of the mouth, attached to the throat (in whisper mode), embedded in scuba equipment, etc. It is preferred that the external microphone 248 have a noise canceling capability to reduce background sounds for clearer recordings or dictation which will enhance the voice recognition software capabilities within the voice identification 126 and the voice-to-text conversion 128 components. In some instances, the aural device 244 may be integrated with an external aural device 244 to create an integrated headset for hands free operations. In these cases, the boom holding the external microphone 248 may be adjustable. The connections between the receiver 246 and external microphone 248 can either be wireless or through a hermetically sealed physical port in the device 200. The external microphone 248 includes a cable adapter plug inserted into the hermetically sealed port. The cable may have a quick disconnect capability.

The encryption 250 is an element that provides for security of the recording contained within the storage device and transmission to the remote device. The encryption 250 is optional and its selection criteria will be based upon cost, state of cryptography and degree of security required. In some implementations, the physical encryption element may be resident within the device 200 due to manufacturing cost considerations, to be activated at a later time via a code. Likewise, if the speech is encrypted in the device 200, it may require decryption to be heard via the internal speaker 243 or the aural device 244.

The Global Positioning System (GPS) 255 is an element within the device 200 that provides for the specific geographic position of the device user 180 at the time of recording the communications. The GPS 255 is optional depending on the implementation. This element obviates the requirement for the user to specify their location since that information will be encoded with the recording and communicated to the information engine 110, template 130 and analytics 136 components.

The internal power supply 260 can be an internal or external battery, solar panel, or state-of-the-art electrical capability. In the event of battery power, the battery(ies) may be internal rechargeable batteries that are reenergized via the recharger 262 or external batteries (rechargeable or non-rechargeable). The external battery pack is used when the expectation that the power source will have to be replaced on a periodic basis. The external battery pack can be in a water resistant or waterproof compartment.

The recharger 262 is an internal or external electrical device that converts an alternating current from an external power supply 264 to a direct current for the internal power supply 260. The recharger 262 may also act as a transformer in reducing the amount of voltage provided to the internal power supply. The transformer may need to be adapted to different voltages and frequencies depending on the country of use. Depending on the implementation, the interface between the recharger 262 and internal power supply 260 or the recharger 262 and the external power supply 264 can be hermetically sealed. The recharger 262 is not necessary when the internal power supply is solar powered, replaceable batteries, etc.

The external power supply 264 is a standard alternating current power source.

The communications interface 270 is an interface between the bus 210 and the communications device 272. In some situations, the communications device 272 may be external to the case, requiring the interface to be hermetically sealed.

The communications device 272 can be external or built-in and provides communications from the device 200 to the network 274. In some implementations, the external communications device 272 may be integrated with the external recharger 262. A built-in device communicates wirelessly as long as it is in close proximity to the network device. The communications device 272 will need to synchronize its transmission with the server 140 over the network (274 or 160).

The network 274 has been previously described in item 160 of diagram 100 of FIG. 1.

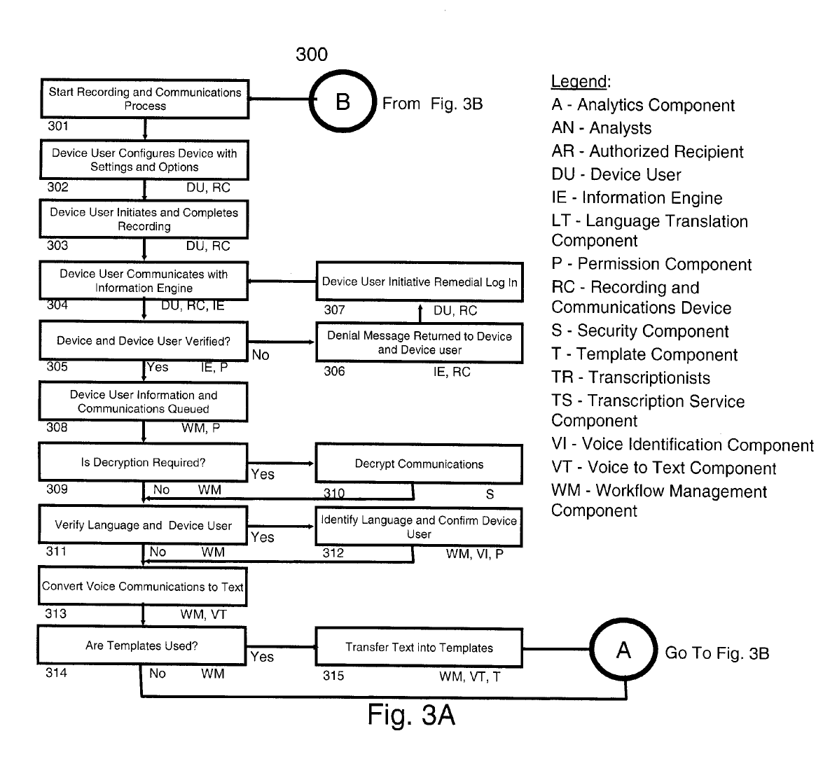

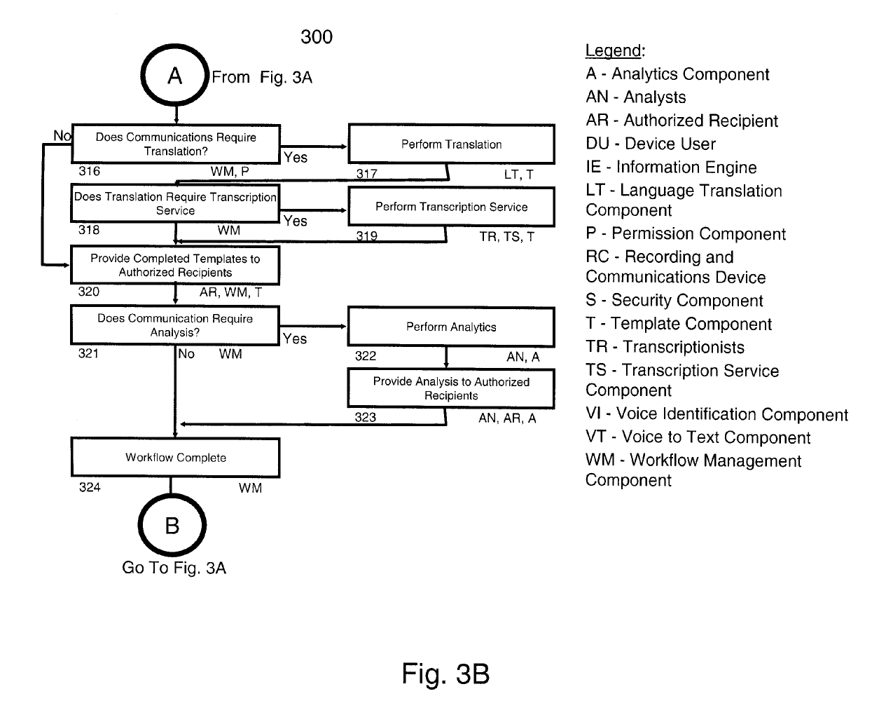

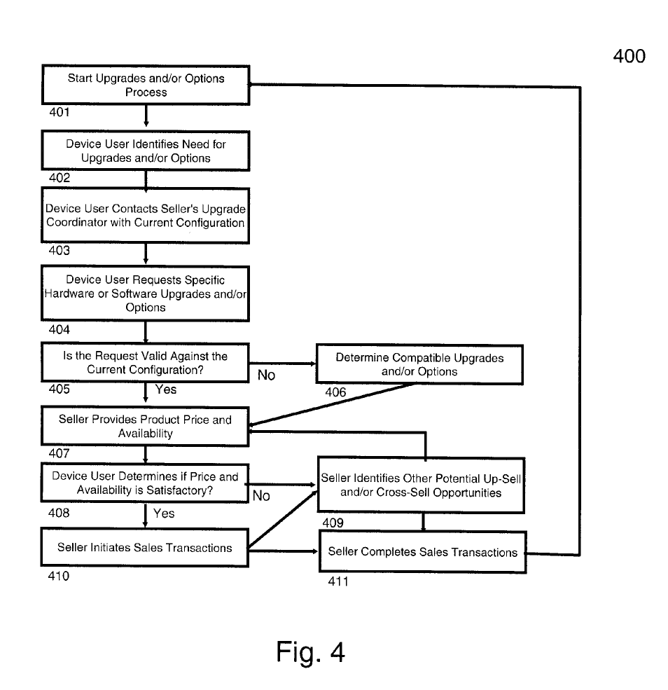

Turning now to FIGS. 3A and 3B, a process flow diagram 300 will now be described. The device user 180 initiates the process at step 301. At step 302, the device user 180 configures the device 200 with settings through the control interface 214 and options depending on the use and situation. FIG. 4 describes the process for upgrading or adding options to the device 200.

At step 303, the device user 180 initiates and completes the verbal recording and stores the communication in the storage unit 224. The communication is date-time stamped from the memory 222 component, and optionally, a location stamp is provided by the GPS 255 component. At step 304, the device user 180 transmits the digital data within the device 200 through the communications interface 270 to the information engine 110 via the network 160/274, the server 140 and the storage 150. At step 305, the permissions component 122 verifies the identity of the device user 180 and the device 200. If the device 200 and/or the device user 180 can not be verified, a denial message (text or code) is returned to the device user 180 at step 306. At step 307, the device user 180 initiates remedial log in procedures and returns to step 304.

If the device 200 and/or the device user 180 are positively verified, the device user information and communications are queued for processing by the workflow management (WM) component 120 at step 308. The workflow management component 120 will date-time stamp the communication and the priority of processing will be initiated and controlled based on the device user 180 and/or authorized recipients' informational needs. The permission (P) component 122 may contain specific entitled data to drive priority of processing. The workflow management component 120 will provide job assignments to users or work groups, deliver reminders to individual users or work groups, and alert supervisors when actions have not been completed within the time prescribed. These alerts may be provided to the system administrator 170 in the event of the server 140, the storage 150 and the network 160 performance issues. For those skilled in the art, the workflow management component 120 will retrieve information from and store data to the storage system 150 through the information engine 110 and the server 140 in accordance with the steps 308 through 324.

At step 309, if decryption of the communications is required, the security (S) component 124 is invoked at step 310. If no decryption is required, the method proceeds directly to step 311.

At step 311, the method determines whether the language and the device user 180 need to be verified. If the language and the device user 180 verifications are not required, the method proceeds to step 313. If the language, dialect and the device user 180 are verified for further processing, the voice identification (VI) component 126 is invoked at step 312. In some deployments, the device user 180's voice will need to be authenticated as part of a two-step security measure with the permissions component 122. This step may be utilized for communications classified as confidential or higher.

At step 313, the voice-to-text conversion (VT) component 128 is utilized to transform digital recorded speech to a text format. A default is used from the permissions component 122 or information provided by the voice identification component 126. At step 314, there is a determination if standardized templates are used. If templates are not required, the method proceeds to step 316. If templates are used, the text from step 313 is transferred to the templates retrieved from the template (T) component 130 at step 315 and stored via the workflow management component 120.

At step 316, the method determines whether the text requires translation to another language. These parameters are set in the permissions component 122 as established by the authorized recipients 186. If no translation is required, the method proceeds to step 320. If translation is required, one or more simultaneous language translations are conducted using the language translation (LT) component 132 at step 317. The output of this step is provided to the transcriptionists 182, the analysts 184 and the authorized recipients 186.

At step 318, the method determines whether the translated text requires a transcription service. If no transcription is required, the method proceeds to step 320. If transcription is required, the text is updated to provide grammatical sense using the transcription (TR) component 134 at step 319. The output of this step is provided to the analysts 184 and the authorized recipients 186.

At step 320, the template formats are updated and two or more forms will be stored (one for the original and two or more for each successive language). Templates are retrieved from the template component 130. The workflow management component 120 will ensure that the translations are tied together for future reference.

At step 321, the method determines whether the communication requires analysis. If no analysis is required, the method proceeds to step 324. If analysis is required, the analytics component 136 is used to model the structured and unstructured data at step 322. Trend analysis, aggregated information, predictive insight, and the like are provided from the analysts 184 to the authorized recipients 186 at step 323.

At step 324, the workflow record is completed and closed. Subsequent iterations may use the stored information for analysis and recalled for one-time use. The process can be repeated by returning to step 301. For those skills in the art would recognize that in some deployments, not all of the components or process steps may be used, or the process steps may be rearranged.

The process flow depicted in flow diagram 400 of FIG. 4 refers to the ordering process for hardware and/or software upgrades and options. A product is comprised of hardware, software, and services. An upgrade provides increased function or capability beyond the current hardware or software configuration. An option provides valid hardware and software accessories, peripherals and warranties to a specific configuration. An option may also include shipping modalities i.e., express delivery, etc. The base or current configuration is the present arrangement of hardware and/or software products.

The upgrade or option ordering process is initiated at step 401. The device user 180, at step 402, identifies a need for hardware and/or software upgrade(s) and/or option(s). The device user 180 contacts the seller's upgrade coordinator 188 with the current configuration (hardware and/or software) at step 403 via the telephone, FAX, mail, Internet, or other means arranged by the seller. At step 404, the device user 180 requests specific hardware and/or software upgrade(s) and/or option(s).

At step 405, the seller validates the device user 180's request against the current configuration using the upgrade component 138. The seller may be the upgrade coordinator (UC) 188 and/or the upgrade (U) component 138. This validation is to ensure the compatibility of the upgrade(s) and/or option(s) with the device user 180's hardware and/or software configuration. This step ensures the highest state of customer satisfaction with the order, that is the upgrade(s) and/or option(s) work properly when the order is fulfilled. If the upgrade and/or option request will not function with the base configuration, the seller at step 406 will determine which upgrade(s) and/or option(s) are compatible with the base configuration and proceed to step 407. If the upgrade and/or option request will function with the base configuration, the process proceeds to step 407.

At step 407, the seller provides product price and availability information to the device user 180. This information is used by the device user 180 to make an informed buy decision. At step 408, the device user 180 determines if the product price and availability is satisfactory, that is the combined value proposition of upgrade(s) and/or option(s), price and availability delivers the requisite quality within expected time frames. If the product price and availability are not satisfactory, the seller at step 409 will determine if other potential up-sell and/or cross-sell opportunities are available and returns to step 407.

If the product price and availability are satisfactory to the device user 180, the seller will initiate the sales transaction at step 410. Step 410 includes adding the device user 180's request into a shopping cart or applicable order entry system. At the seller's discretion, the seller may go to step 409 to identify additional up-sell and/or cross-sell opportunities to drive increased revenue and profitability. For those skilled in the art, the process of up-selling and cross-selling may occur over several iterations. In some cases, the up-sell and/or cross-sell was not successful, the process proceeds to step 411. At step 411, the seller completes the sales order which may include obtaining user identification, payment method, delivery instructions, etc.

The embodiments of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

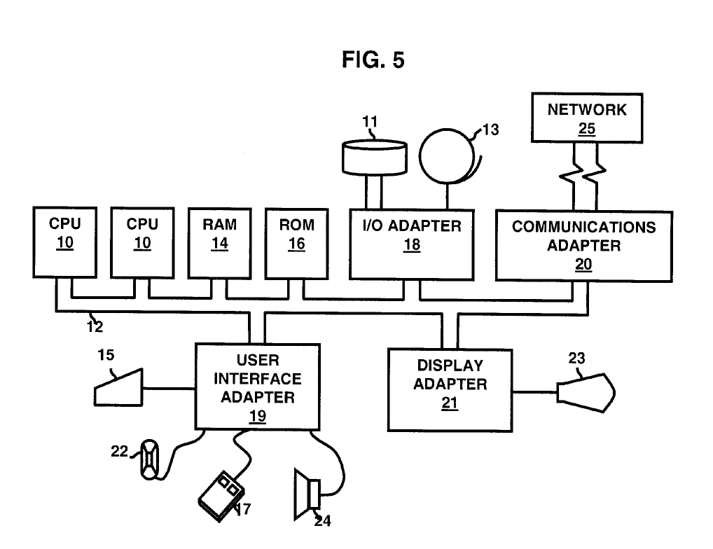

A representative hardware environment for practicing the embodiments of the invention is depicted in FIG. 5. This schematic drawing illustrates a hardware configuration of an information handling/computer system in accordance with the embodiments of the invention. FIG. 5 supports the client systems (170-188) which are connected to a network (25 and 160). The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A network system for a waterproof recording and communications device, comprising:
an information engine;
a plurality of system components operatively connected to said information engine,
wherein said system components comprise at least one of a workflow management component, a permissions component, a security component, a voice identification component, a voice-to-text conversion component, a template component, language translation component, a transcription service component, an analytics component, and an upgrade component;
a server operatively connected to said information engine and adapted to execute said information engine;
a storage system operatively connected to said server and adapted to store electronic information to be retrieved and manipulated by said server; and
a network operatively connected to said server and adapted to connect said server to a plurality of client systems,
wherein said client systems comprise at least one of a system administrator, a system supervisor, a device user, a transcriptionist, an analyst, an authorized recipient, and an upgrade coordinator.

2. The network system according to claim 1, wherein said workflow management component is adapted to place stamps on system transactions, wherein said stamps comprise at least one of date data, time data, and geographic location data.

3. The network system according to claim 1, wherein:
said workflow management component is adapted to process incoming transmissions;
said permissions component is adapted to permit user access into said information engine;
said security component is adapted to protect received information;
said voice identification component is adapted to determine spoken language and identify a speaker;
said voice-to-text conversion component is adapted to convert speech into text;
said template component is adapted to store pre-formatted recording templates;
said language translation component is adapted to translate said text from said voice-to-text conversion component to at least one specified language;
said transcription service component is adapted to provide transcriptionists and interpreters to ensure that said text is grammatically correct;
said analytics component is adapted to build data models that analyze verbal information; and
said upgrade component is adapted to maintain at least one of records of at least one of hardware and software upgrades and options to recording and communication devices.

4. The network system according to claim 1, wherein:
said system administrator is adapted to manage said server, said storage system and said network;
said system supervisor is adapted to control said workflow management component, said permissions component, and said security component;
said device user is adapted to transmit data to said information engine;
said transcriptionist is adapted to provide quality control over at least one of said voice-to-text conversion component and said language translation component;
said analyst is adapted to manage said analytics component;
said authorized recipient is adapted to receive information from said device user; and
said upgrade coordinator is adapted to manage at least one of upgrades to one of hardware components of said recording and communications device and software components of said recording and communication device and options to one of hardware components of said recording and communications device and software components of said recording and communication device.

5. A waterproof recording and communications device, comprising:
a bus;
a memory element operatively connected to said bus, wherein said memory element comprises program memory for data and applications;
a control element operatively connected to said bus and adapted to direct said applications;
a control interface operatively connected to said bus and adapted to receive instructions from said control element and send signals to a processing unit, wherein said signals comprise instructions to said processing unit to perform at least one of said applications;
an input/output interface operatively connected to said bus;
a receiver operatively connected to said bus;
a transmitter operatively connected to said bus;
a microphone operatively connected to said bus;
a storage unit operatively connected to said bus,
wherein said receiver is adapted to convert verbal information from said microphone to digital information, wherein said receiver is further adapted to send said digital information to at least one of said bus, said input/output interface, and said storage unit,
and wherein said transmitter is adapted to convert said digital information from at least one of said storage unit and said input/output interface to verbal information, wherein said transmitter is further adapted to send said verbal information to at least one of an internal speaker and an external aural device;
a communications interface operatively connected to said bus; and
a communications device operatively connected to said bus, wherein said communications device is adapted to operatively connect said device to a network.

6. The device according to claim 5, wherein said storage unit is adapted to place stamps on said digital information, wherein said stamps comprise at least one of date data, time data, and geographic location data.

7. The device according to claim 5, further comprising an encryption element operatively connected to said bus and adapted to provide security of said digital information.

8. The device according to claim 5, further comprising a global positioning system element operatively connected to said bus and adapted to identify a geographic position of said device when said verbal information is received by said microphone.

9. The device according to claim 5, wherein said microphone comprises at least one of an internal microphone and an external microphone, wherein said internal microphone is adapted to receive verbal information and send said verbal information to said storage unit via said input/output interface and said receiver, and wherein said external microphone is adapted to send said verbal information to said receiver.

10. The device according to claim 5, further comprising a case adapted to enclose said device, wherein said case is at least one of water resistant and waterproof.

11. The device according to claim 10, wherein said case permits hermetically sealed electronic interfaces between at least one of said visual display interface and said control interface; said transmitter and said aural device; said receiver and said external microphone; said internal power supply and said recharger; said internal power supply and said external power supply; said communications interface and said communications device; and, said communications device and said network.

12. The device according to claim 5, further comprising a visual display interface operatively connected to said bus and adapted to display a status of said device.

13. The device according to claim 5, further comprising an internal speaker operatively connected to said bus and adapted to receive and transmit verbal comments from said storage unit.

14. The device according to claim 5, further comprising an aural device operatively connected to said bus and adapted to receive and transmit verbal comments from said transmitter.

15. A method, comprising:
configuring a recording and communications device with settings and options through a control interface;
recording information within said recording and communications device, comprising storing said information within a storage unit;
transmitting said information to an information engine via a network, a server and said storage unit;
sending a denial message to a device user via a permissions component when at least one of said device user and said recording and communications device cannot be verified;
initiating remedial log in procedures when said denial message is received by said device user;
queuing device user information and communications for processing by a workflow management component when at least one of said device user and said recording and communications device can be verified;
invoking a security component when decryption of said communications is required;
invoking a voice identification component when said language and said device user are verified;
converting said information to text via a voice-to-text conversion component;
transferring said text to templates retrieved from a template component when said templates are used;
conducting language translations of said text via a language translation component when said language translation of said text is required;
performing transcription of said text via a transcription component when said transcription of said text is required;
providing said templates to devices users and authorized recipients;
performing analytics via an analytics component to model structured and unstructured data and providing results of said analytics to authorized recipients when said analysis is required; and
completing and closing a workflow record.

16. The method according to claim 15, further comprising stamping said information with at least one of date data, time data, and geographic location data.

17. The method according to claim 15, wherein said recording of said information within said recording and communications device is conducted in a wet environment.

18. A computer program product comprising a computer usable medium having a computer readable program, wherein the computer readable program, when executed on a computer, causes the computer to perform a method, comprising:
configuring a recording and communications device with settings and options through a control interface;
recording information within said recording and communications device, comprising storing said information within a storage unit;
transmitting said information to an information engine via a network, a server and said storage unit;
sending a denial message to a device user via a permissions component when at least one of said device user and said recording and communications device cannot be verified;
initiating remedial log in procedures when said denial message is received by said device user;
queuing device user information and communications for processing by a workflow management component when at least one of said device user and said recording and communications device can be verified;
invoking a security component when decryption of said communications is required;
invoking a voice identification component when said language and said device user are verified;
converting said information to text via a voice-to-text conversion component;
transferring said text to templates retrieved from a template component when said templates are used;
conducting language translations of said text via a language translation component when said language translation of said text is required;
performing transcription of said text via a transcription component when said transcription of said text is required;
providing said templates to devices users and authorized recipients;
performing analytics via an analytics component to model structured and unstructured data and providing results of said analytics to authorized recipients when said analysis is required; and
completing and closing a workflow record.

19. The computer program product according to claim 18, further comprising stamping said information with at least one of date data, time data, and geographic location data.

20. The computer program product according to claim 18, wherein said recording of said information within said recording and communications device is conducted in a wet environment.
